(19) United States
(12) Patent Application Publication
(10) Pub. No.: US 2026/0124756 A1
(43) Pub. Date: May 7, 2026

(54) METHOD AND SYSTEM FOR CALIBRATION USING A TOUCH SCREEN

(71) Applicant: ABB SCHWEIZ AG, Baden (CH)

(72) Inventors: Kun Chang, Shanghai (CN); Hao Gu, Shanghai (CN); Lei Mao, Shanghai (CN); Changnian Qian, Shanghai (CN); Jing Ma, Shanghai (CN)

(21) Appl. No.: 19/441,162

(22) Filed: Jan. 6, 2026

Related U.S. Application Data
(63) Continuation of application No. PCT/CN2023/106412, filed on Jul. 7, 2023.

(51) Int. Cl. B25J 9/16; G06F 3/041

(52) U.S. Cl. CPC B25J 9/1692; B25J 9/1664; G06F 3/04162

(57) ABSTRACT

A method includes obtaining a first set of coordinates of the at least three points in a robot coordinate system and a second set of coordinates of the at least three points in a touch screen coordinate system; causing the conveyor to move from the first position to a second position different from the first position; obtaining a third set of coordinates of the at least further three points in the robot coordinate system and a fourth set of coordinates of the at least three further points in the touch screen coordinate system; and determining a conveyor coordinate of the conveyor in the robot coordinate system based on the first set of coordinates, the second set of coordinates, the third set of coordinates and the fourth set of coordinates.

### FIELD

Embodiments of the present disclosure generally relate to calibrating peripheral devices for an industrial robot and in particular to a method and a system for calibrating peripheral devices for an industrial robot using a touch screen.

### BACKGROUND

With repaid development of industrial automation, industrial robots are widely and increased used in an industrial field. More and more peripheral devices, such as conveyors, cameras, and the like, are used to cooperate with the industrial robot so as to enhance performances of the industrial robot. Before these peripheral devices are put into use, these peripheral devices have to be calibrated so that the industrial robot can identify and locate these devices. Thus, the industrial robot can precisely and synchronically cooperate with these peripheral devices to perform various tasks in the industrial field.

However, calibrating these peripheral devices is typically complex, tedious and operator-dependent. Conventional calibration methods are subject to the following drawbacks. Different peripheral device requires different calibration methods. Even though a calibration manual or specification is provided for each peripheral device, there is no uniform method that is configured to calibrate multiple peripheral devices. Also, most calibration methods still require participation of professional personnel, which is inconvenient for a customer, who lacks the professional knowledge for calibration, resulting in increased costs. Another disadvantage is that calibration methods more or less need manual intervention. This results that the calibration results are highly operator-dependent and are prone to human errors. There is a need to improve conventional calibration method.

### SUMMARY

Example embodiments of the present disclosure provide a method and a system for calibrating peripheral devices associated with an industrial robot using a touch screen which can obviate or mitigate at least one of the above mentioned problems.

In a first aspect of the present disclosure, there is provided a method for calibration using a touch screen. The method comprises: obtaining, in response to a touch component touching at least three points being not collinear on a touch screen when a conveyor associated with an industrial robot is at a first position, a first set of coordinates of the at least three points in a robot coordinate system and a second set of coordinates of the at least three points in a touch screen coordinate system, the touch component being mounted on a manipulator of the industrial robot, and the touch screen being placed on the conveyor and stationary with respect to the conveyor; causing the conveyor to move from the first position to a second position different from the first position; obtaining, in response to the touch component touching at least further three points being not collinear on the touch screen when the conveyor is at the second first position, a third set of coordinates of the at least further three points in the robot coordinate system and a fourth set of coordinates of the at least three further points in the touch screen coordinate system; and determining a conveyor coordinate of the conveyor in the robot coordinate system based on the first set of coordinates, the second set of coordinates, the third set of coordinates and the fourth set of coordinates. With this method, by using the touch screen which can record the touching points in its own touch screen coordinate system, processes for calibrating the conveyor can be simplified.

In some embodiments, the method may further comprise: obtaining a first value from an encoder of the conveyor when the conveyor is at the first position; obtaining a second value from the encoder when the conveyor is at the second position; obtaining third values from an acceleration sensor and a gyroscope of the touch screen during movement of the conveyor from the first position to the second position; determining, based on the third values, a moving direction and a moving distance of the touch screen during movement of the conveyor from the first position to the second position; determining, based on the first value, the second value, and the determined moving direction and the moving distance of the touch screen, a relationship between a count of the encoder and the movement of the conveyor. With this method, by using the acceleration sensor and the gyroscope of the touch screen, the rough moving direction and the rough moving distance of the touch screen can be determined. Thus, the encoder of the conveyor can be automatically calibrated.

In some embodiments, the touch component touching the at least three points when the conveyor is at the first position comprises causing the manipulator to move in response to a teaching input from a user to cause the touch component to touch the at least three points on the touch screen. With this method, the touch screen can be touched by teaching inputs.

In some embodiments, the method may further comprise: determining, based on the moving direction and the moving distance, a first coordinate of the touch screen in the robot coordinate system when the conveyor is at the second position; and causing, based on the determined first coordinate of the touch screen, the manipulator to move without a teaching input from a user to cause the touch component to touch the at least further three points on the touch screen. With this method, the touch screen can be automatically touched, with reduced human's intervention.

In some embodiments, the method may further comprise determining, based on at least one of the moving direction and the moving distance, whether the conveyor is a linear conveyor or a circular conveyor. With this method, the type of the conveyor can be automatically identified.

In some embodiments, the at least three points and/or the at least further three points are arbitrary points on the touch screen that are not collinear. Thus, as long as the touch screen can be touched by the touching component, the calibration can be achieved and there is no need for the touching component to touch the same teaching point as the previous touch. This improves the automation degree of calibration and reduces need of human's intervention.

In some embodiments, the method may further comprise causing the touch screen to display a checkerboard pattern; causing a camera to capture an image of the touch screen displaying the checkerboard pattern, the camera being mounted above the conveyor; and determining, based on the captured image, a position relationship between the camera and the touch screen. With this method, the self-illuminating of the touch screen ensures the resolution and brightness of the checkerboard pattern, which reduces requirements for the lighting conditions.

In some embodiments, the method may further comprise: determining, based on the first and second sets of coordinates or the third and fourth sets of coordinates, a second coordinate of the touch screen in the robot coordinate system; and determining, based on the position relationship and the determined second coordinate, a camera coordinate of the camera in the robot coordinate system. With this method, due to use of the first and second sets of coordinates or the third and fourth sets of coordinates, the hand-eye calibration can be automatically performed. This is beneficial since the camera and the conveyor can be calibrated at the same time.

In some embodiments, the method may further comprise: (a) causing the touch screen to display an object to be touched at a predetermined position in the touch screen; (b) causing the camera to capture an image of the touch screen displaying the object to be touched; (c) determining, based on the captured image, a third coordinate of the object in the robot coordinate system; (d) causing the manipulator to move to cause the touch component to touch the object in the touch screen based on the third coordinate; and (e) obtaining, in response to the touch component touching the object in the touch screen, a fourth coordinate of the touched point in the camera coordinate system. With this method, by recording data related to the touched point, performances of the camera and the picking-up accuracy of the manipulator can be analyzed.

In some embodiments, the method may further comprise: causing the touch screen to sequentially display a plurality of objects to be touched in a predetermined time sequence; for each object to be touched, repeating the steps (a)-(e) to obtain a plurality of the touched points at which the touch component touches the touch screen; and outputting the plurality of the touched points for analyzing a performance of at least one of the camera and the manipulator. By recording the plurality of the touched points, performances of the camera and the picking-up accuracy of the manipulator can be more comprehensively analyzed.

In some embodiments, the method may further comprise obtaining, from the touch screen, time information that the touch component touches the object in the touch screen; and outputting the time information for analyzing a performance of at least one of the manipulator and the conveyor. By recording the time information, the performances of the manipulator and the conveyor associated with the time parameter can be comprehensively analyzed.

In some embodiments, the method may further comprise obtaining, in response to a second touch component touching at least three points being not collinear on the touch screen when the conveyor is at a third position different from the first position and the second position, a fifth set of coordinates of the at least three points in a second robot coordinate system and a sixth set of coordinates of the at least three points in the touch screen coordinate system, the second touch component being mounted on a second manipulator of a second industrial robot; determining a second conveyor coordinate of the conveyor in the second robot coordinate system based on the fifth set of coordinates and the sixth set of coordinates. In this way, the second industrial robot within the system can also be calibrated.

In some embodiments, the method may further comprise causing the touch screen to display a checkerboard pattern when the touch screen is located near a second camera being mounted above the conveyor; causing the second camera to capture an image of the touch screen displaying the checkerboard pattern; and determining, based on the captured image, a position relationship between the second camera and the touch screen. In this way, the second camera within the system can also be calibrated.

In a second aspect of the present disclosure, there is provided a system for calibration a conveyor associated with an industrial robot. The system comprises a touch screen placed on the conveyor and stationary with respect to the conveyor; and a controller communicatively connected to the touch screen and the industrial robot, the controller being configured to: obtain, in response to a touch component mounted on a manipulator of the industrial robot touching at least three points being not collinear on the touch screen when the conveyor is at a first position, a first set of coordinates of the at least three points in a robot coordinate system and a second set of coordinates of the at least three points in a touch screen coordinate system; cause the conveyor to move from the first position to a second position different from the first position; obtain, in response to the touch component touching at least further three points being not collinear on the touch screen when the conveyor is at the second first position, a third set of coordinates of the at least further three points in the robot coordinate system and a fourth set of coordinates of the at least three further points in the touch screen coordinate system; and determine a conveyor coordinate of the conveyor in the robot coordinate system based on the first set of coordinates, the second set of coordinates, the third set of coordinates and the fourth set of coordinates.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is an overall schematic view of a system for calibrating peripheral devices of an industrial robot system using a touch screen according to one example embodiment of the present disclosure;

FIG. 2 is a partial perspective schematic view of FIG. 1 for calibrating a conveyor using a touch screen according to one example embodiment of the present disclosure;

FIG. 3 is a flowchart of a method for calibrating a conveyor using a touch screen according to one example embodiment of the present disclosure;

FIG. 4 is a flowchart of a method for calibrating an encoder of a conveyor using a touch screen according to one example embodiment of the present disclosure;

FIG. 5 is an overall schematic view of a system for hand-eye calibration of an industrial robot system using a touch screen according to one example embodiment of the present disclosure;

FIG. 6 is a flowchart of a method for hand-eye calibration using a touch screen according to one example embodiment of the present disclosure;

FIG. 7 is an overall schematic view of a system for performances analysis of the components constituting the industrial robot system using a touch screen according to one example embodiment of the present disclosure;

FIG. 8 is a flowchart of a method for analyzing a performance of the system using a touch screen according to one example embodiment of the present disclosure; and

FIG. 9 shows a recording result displayed on the touch screen according to one example embodiment of the present disclosure;

FIG. 10 shows a block diagram of an example device adapted to implement the embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

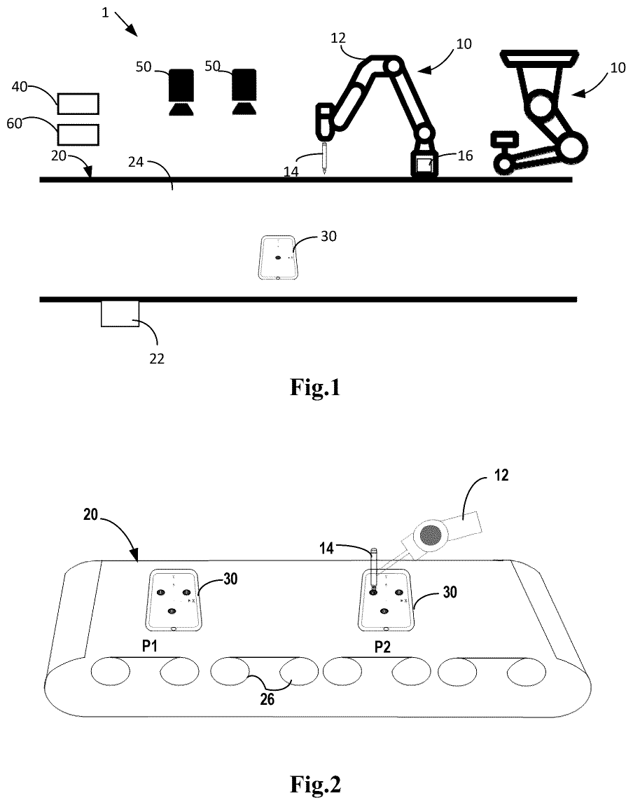

FIG. 1 is an overall schematic view of a system for calibrating peripheral devices of an industrial robot system 1 using a touch screen 30 according to one example embodiment of the present disclosure. As shown in FIG. 1, the industrial robot system 1 includes an industrial robot 10 and a conveyor 20 which is an example of a conveying device for conveying workpieces (not shown) thereon.

The industrial robot 10 include a manipulator 12 formed by a plurality of arms and actuators and a controller 16 configured to control the actuators. By the controller 16, the manipulator 12 is movable and adopts various postures within a working area. It is to be understood that the shown industrial robot 10 is merely illustrative and the industrial robot 10 may be of any other types.

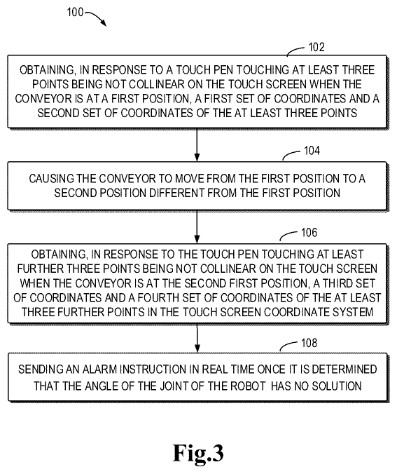

The conveyor 20 may be of various forms, such as a linear conveyor, and a circular conveyor. In the shown example, the conveyor 20 is a linear conveyor. The conveyor 20 may include a conveying platform 24 (for example a conveying belt in the shown example) and rollers 26 (shown in FIG. 2) which are configured to rotate to move the conveying platform 24 so as to sequentially convey workpieces on the conveying platform 24. An encoder 22 may be provided in the conveyor 20 and outputs a count according to a movement amount of the conveyor 10. The count may indicate a movement speed of the conveyor 20. A camera 50 may be provided near the conveyor 20. The camera 50 is an imaging component and is configured to capture images. Images captured by the camera 50 are output to a controller, for example, to the controller 16. Positions of the workpieces can be determined in accordance with the captured images.

The industrial robot 20 is disposed near the conveyor 20. An end effector, such as a tool, may be arranged on the end flange of the industrial robot 20. The industrial robot 20 is configured to, for example, picks up the workpieces on the conveyor 20 and places the workpieces to a different positon for further processing the workpieces. During operation of the industrial robot system 1, the workpieces are sequentially convened on the conveyor 20. As the conveyor 20 moves, the industrial robot 20 identify the workpieces on the conveyor 20 and pick up the workpieces synchronically once the workpieces are located within a reach area of the industrial robot 20.

In the shown arrangement of the industrial robot system 1, only one camera 50 and one industrial robot 10 is shown. It is to be understood that the shown arrangement of the industrial robot system 1 are merely illustrative. The industrial robot system 1 may include more industrial robots, more cameras, and one or more conveyors. These peripheral devices, such as conveyors, cameras, and the like, should be calibrated before they are put to use. According to the present disclosure, a novel method and a novel system is proposed which can conveniently calibrate these peripheral devices easily by use of a touch screen.

As shown in FIG. 1, a system for calibrating the peripheral devices may include a calibration controller 40, a touch pen 14, and a touch screen 30. The calibration controller 40 is a computing device which is configured to perform various calculations. In the shown example, the calibration controller 40 is shown as a separate device and is communicatively connected to the robot controller 16. It is to be understood that this is merely illustrative and the calibration controller 40 may be integrated within the robot controller 16. In the shown example, the calibration controller 40 may also be communicatively connected to the peripheral devices to be calibrated, such as the camera 50 and the encoder 22. The touch pen 14 is releasably fixed mounted at an end flange of the manipulator 12. It is to be understood that the touch pen 14 is merely illustrative and the touch component may be any other proper component. As the manipulator 12 moves within the working area, the position of the touch pen 14 within the space can be controlled. The touch pen 14 is driven to touch the touch screen 30 placed on the conveyor 20 during the calibration process. Once the industrial robot 12 is calibrated, a coordinate of the touch pen 14 (a TCP coordinate) is known in the robot coordinate system (also called the robot base coordinate system). That is, the coordinate of the touch pen 14 is known by the industrial robot.

The touch screen 30 may be placed on the conveying platform 24 of the conveyor 20. The touch screen 30 keeps stationary with respect to the conveying platform 24 during the calibration process. In some embodiments, fastener means may be used to fix the touch screen 30 onto the conveying platform 24. As the conveyor 20 moves, the touch screen 30 moves accordingly. The touch screen 30 is an electronic display device that is configured to receive touch inputs from a user via a finger or touch pen and to record positions of these inputs in the display screen. The display screen of the touch screen is used as not only an input device but also an output device. The touch screen 30 includes its own coordinate system (also called a touch screen coordinate system). When a pin, for example, the touch pen 14, touches the display screen, the display screen records the coordinate of the touch point at which the pin contacts the display screen. Various electronic devices may be used as the touch screen 30 as long as it can receive and record the user's touching input. A tablet, a notebook computer, a smartphone, and the like, are example embodiments of the touch screen 30. In some embodiments, the touch screen 30 may include inertial motion sensors, such as accelerometers and gyroscopes. These sensors may bring about technical advantages in implementing some embodiments of the present disclosure, which will be described later, since data from the inertial motion sensors can be used to track a movement of the touch screen 30.

In the shown example, a teaching controller 60 may also be provided. The teaching controller 60 is configured to control a posture of the manipulator 12 which in turn controls the position of the touch pen 14 mounted at the end flange of the manipulator 12 in the work space of the industrial robot. The teaching controller 60 may include user's input interfaces. The teaching controller 60 is also communicatively connected to the robot controller 16. User's commands for moving the manipulator 12 may be input via the teaching controller 60. In the shown example, the teaching controller 60 is shown as a separate device for controlling movement of the manipulator 12. It is to be understood that that this is merely illustrative and the teaching controller 60 bay be omitted. For example, the movement path of the touch pen 14 can be directly controlled by applying forces to the manipulator 12.

In the shown example, two cameras 50 and two industrial robots 10 are included. It is to be understood that the robot system 1 may include any other number of industrial robots 10 and cameras 50.

FIG. 2 is a partial perspective schematic view of FIG. 1 for calibrating a conveyor 20 using a touch screen 30 according to one example embodiment of the present disclosure. In some embodiments, before the method of the present disclosure is performed, the touch pen 14 mounted on the manipulator 12 should first be calibrated. Thus, the positions of the touch pen 14 are known by the industrial robot. The positions of the touch pen 14 are identified as TCP in the robot coordinate system. That is, wherever the touch pen 14 is, the industrial robot knows the coordinate of the touch pen 14 in the robot coordinate system. There are various methods for calibrating the touch pen 14, such as a CrossBeam method, a manual four-point method, and the like, to calibrate the TCP of the touch pen 14. Since these methods are well known in the art, their description is omitted.

After the TCP of touch pen 14 is calibrated, the conveyor 20 is calibrated by touching the touch screen 30 via the touch pen 14. As shown in FIG. 2, a touch screen 30 is fixed on the conveyor 20 and keeps stationary with respect to the conveyor 20 (in particular, the conveying platform 24). When the conveyor 20 is at a first position P1, the touch pen 14 mounted on the manipulator 12 is moved so as to touch at least three points on the touch screen 30 via moving the manipulator 12. The at least three points are not collinear on the touch screen 30. The non-collinear three points are sufficient for determining a plane at which the touch screen 30 is located. As the industrial robot knows the coordinate of the touch pen 14 in the robot coordinate system, a first set of coordinates of the at least three points in a robot coordinate system can be recorded by the robot controller 16. The first set of coordinates of the at least three points in the robot coordinate system can be further communicated to the calibration controller 40 from the robot controller 16. Meanwhile, the at least three points are located in the touch screen 30. The touch screen 30 also knows the coordinates of the at least three points within the touch screen coordinate system which are recorded as a second set of coordinates of the at least three points in the touch screen coordinate system. The second set of coordinates of the at least three points in a touch screen coordinate system can be further communicated to the calibration controller 40 from the touch screen 30.

After the first set of coordinates of the at least three points in the robot coordinate system and the second set of coordinates of the at least three points in the touch screen coordinate system are recorded, the conveyor 20 is driven move from the first position P1 to a second position P2. When the conveyor 20 is at the second position P2, the touch pen 14 mounted on the manipulator 12 is moved so as to touch at least further three points on the touch screen 30 via moving the manipulator 12.

The at least further three points are not collinear on the touch screen 30. As the industrial robot knows the coordinate of the touch pen 14 in the robot coordinate system, a third set of coordinates of the at least further three points in the robot coordinate system can be recorded by the robot controller 16. The third set of coordinates of the at least three points in the robot coordinate system can be further communicated to the calibration controller 40 from the robot controller 16. Meanwhile, the at least further three points are located in the touch screen 30. The touch screen 30 also knows the coordinates of the at least further three points within the touch screen coordinate system which are recorded as a fourth set of coordinates of the at least three points in the touch screen coordinate system. The fourth set of coordinates of the at least three points in the touch screen coordinate system can be further communicated to the calibration controller 40 from the touch screen 30.

When the calibration controller 40 obtains the first set of coordinates, the second set of coordinates, the third set of coordinates and the fourth set of coordinates, a relative position relationship between the conveyor and the robot coordinate system is thus determined based on the first set of coordinates, the second set of coordinates, the third set of coordinates and the fourth set of coordinates. That is, a coordinate of the conveyor within the robot coordinate system can be determined based on the first set of coordinates, the second set of coordinates, the third set of coordinates and the fourth set of coordinates.

In the shown example, the at least three points at which the touch pen 14 touches the touch screen 30 when the conveyor is at the first position are not necessarily to be the same as the at least further three points when the conveyor is at the second position. Rather, the at least three points and the at least further three points are arbitrary points on the touch screen 30 as long as they are not collinear respectively. This is beneficial in improving calibration. In some embodiments, three non collinear points are used in calibration. In some other embodiments, more than three points are used for calibration. More than three points may provide calculation redundancy during calibration.

After the conveyer 20 is calibrated for one industrial robot 10, the conveyer can be calibrated for the second industrial robot 10 in an analogous way. To be specific, as the conveyor moves to a third position different from the first position and the second position, a second touch component 14 of the second industrial robot 10 is caused to touch at least three points being not collinear on the touch screen. Then, a fifth set of coordinates of the at least three points in a second robot coordinate system and a sixth set of coordinates of the at least three points in the touch screen coordinate system are obtained. A conveyor coordinate of the conveyor in the second robot coordinate system can thus be determined based on the fifth set of coordinates and the sixth set of coordinates. In this way, even multiple robots are arranged along the conveyer 20, the conveyer 20 can be easily calibrated for each of the multiple robots by moving the conveyer 20 to different positions and by causing the touch component 14 on the respective industrial robot 10 to touch the at least three points being not collinear on the touch screen.

FIG. 3 is a flowchart of a method 100 for calibrating the conveyor 20 using the touch screen 30 according to one example embodiment of the present disclosure. As shown in FIG. 3, in the method 100, at a block 102, in response to a touch pen 14 touching at least three points being not collinear on the touch screen 30 when the conveyor 20 is at a first position, a first set of coordinates of the at least three points in a robot coordinate system and a second set of coordinates of the at least three points in a touch screen coordinate system are obtained. At a block 104, the conveyor 20 is caused to move from the first position to a second position different from the first position. At a block 106, in response to the touch pen 14 touching at least further three points being not collinear on the touch screen 30 when the conveyor 20 is at the second first position, a third set of coordinates of the at least further three points in the robot coordinate system and a fourth set of coordinates of the at least three further points in the touch screen coordinate system are obtained. At a block 108, a coordinate of the conveyor in the robot coordinate system is determined based on the first set of coordinates, the second set of coordinates, the third set of coordinates and the fourth set of coordinates.

In some embodiments, in addition to calibrating the relative position relationship between the conveyor and the industrial robot, the method may further comprises calibrating the encoder 22 of the conveyor 20. When the touch screen 30 may include inertial motion sensors, such as accelerometers and gyroscopes, the calibration of the encoder 22 can be automatically performed by tracking a movement path of the touch screen 30.

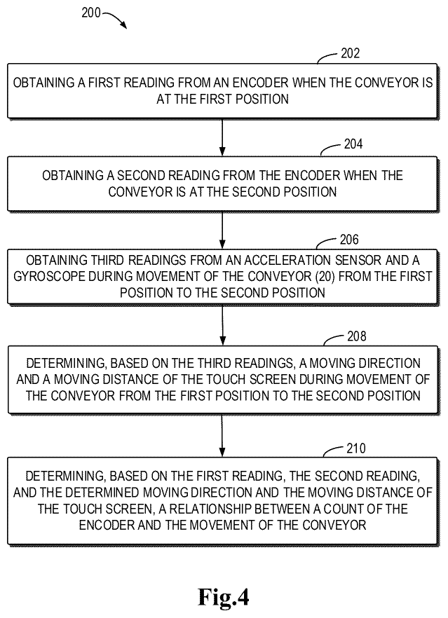

FIG. 4 is a flowchart of a method 200 for calibrating an encoder of a conveyor using a touch screen according to one example embodiment of the present disclosure. As shown in FIG. 4, in the method 200, at a block 202, a first value of the encoder 22 is obtained when the conveyor 20 is at the first position. The encoder 22 is communicatively connected to the calibration controller 40. When the conveyor 20 is at the first position, the calibration controller 40 can obtain the value from the encoder 22. At a block 204, a second value of the encoder 22 is obtained when the conveyor 20 is at the second position. Likewise, when the conveyor 20 is at the second position, the calibration controller 40 can obtain the value from the encoder 22. At a block 206, third values from the acceleration sensor and the gyroscope during movement of the conveyor (20) from the first position to the second position are obtained. At a block 208, a moving direction and a moving distance of the touch screen 30 during movement of the conveyor 20 from the first position to the second position are determined based on the third values. In this case, the acceleration sensor and the gyroscope are used as means for inertial navigation. Even if the accuracy of the inertial navigation is not so high, it is sufficient to determine the rough moving direction and rough moving distance of the touch screen 30 from the first position to the second position. At a block 210, a relationship between a count of the encoder 22 and the movement of the conveyor 20 can be determined based on the first value, the second value, and the determined moving direction and the moving distance of the touch screen. When a movement distance of the touch screen from the first position to the second position is determined, the determined distance divided by a difference between the second value and the first value results in the relationship between a count of the encoder 22 and a movement of the conveyor 20. In this way, the encoder 22 of the conveyor 20 can be calibrated automatically.

In some embodiments, when the conveyor 20 is at the first position, the touch pen 14 is moved to touch the touch screen 30 via teaching inputs. For example, in one example, the user may input commends for moving the manipulator 12 to the teaching controller 60 via user interfaces of the teaching controller 60. In some examples, the manipulator 12 may be moved by the user directly by applying forces to the manipulator 12. In some embodiments, when the conveyor 20 is at the second position, the touch pen 14 may be moved to touch the touch screen 30 via teaching inputs.

In other embodiments, when the conveyor 20 is at the second position, the touch pen 14 may be moved to touch the touch screen 30 by automatic control without teaching inputs. This may be beneficial in further improving calibration efficiency. As the rough moving direction and the rough moving distance from the first position to the second position is known, a first coordinate of the touch screen 30 in the robot coordinate system can be determined, for example, by the calibration controller 40, when the conveyor 20 is at the second position. The calibration controller 40 may send the first coordinate to the robot controller 16. The manipulator 12 is instructed by the robot controller 16 to move to cause the touch pen 14 to touch the at least further three points on the touch screen 30, without a teaching input from a user. This process does not need human's intervention. Accordingly, the calibration process of the present disclosure can reduce human's participation or teaching.

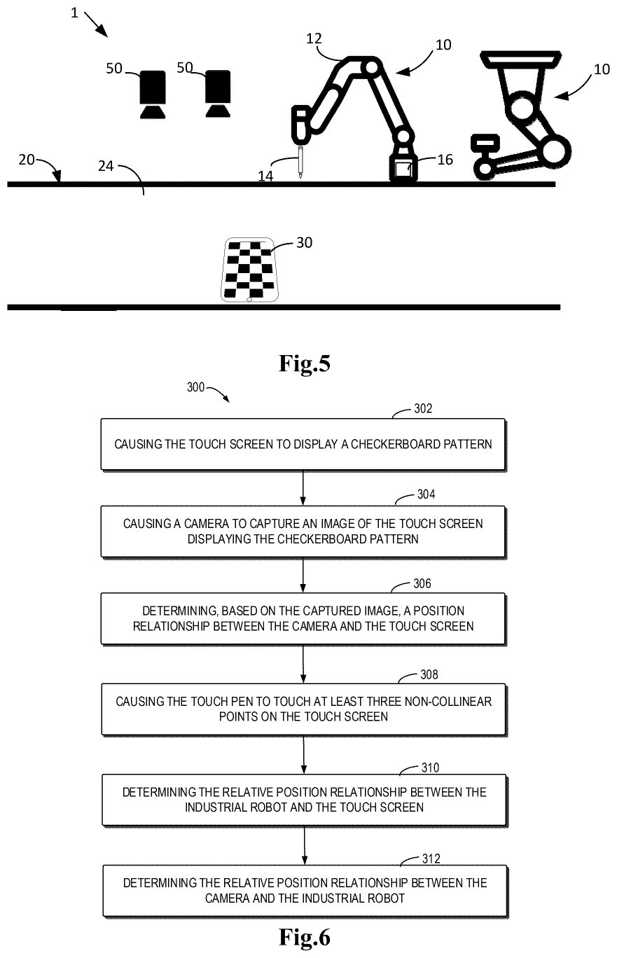

FIG. 5 is an overall schematic view of a system for hand-eye calibration of an industrial robot system using a touch screen according to one example embodiment of the present disclosure. The system for calibrating the peripheral devices may be used to calibrate the camera 50, which is also called hand-eye calibration. The hand-eye calibration is configured to figure out a position relationship between the camera 50 and the industrial robot 10.

In some embodiments, before calibrating the camera 50, the touch pen 14 mounted on the manipulator 12 should first be calibrated. After the TCP of touch pen 14 is calibrated, a touch screen 30 may be placed on any position of the conveyor 20 (or any other platforms) and keeps stationary with respect to the conveyor 20 (in particular, the conveying platform 24). The touch screen 30 is instructed to display a checkerboard pattern, for example in response to instructions from the calibration controller (not shown). The checkerboard pattern may be of various forms, as well known in the art for hand-eye calibration. Then, the camera 50 is instructed to capture an image of the touch screen 30 displaying the checkerboard pattern. Based on the captured images including the touch screen 30 displaying the checkerboard pattern, a relative position relationship between the camera and the touch screen 30 is determined.

Then, the manipulator 12 of the industrial robot is instructed to move, for example, in response to instructions from the calibration controller. The touch pen 14 mounted on the manipulator 12 is moved correspondingly so as to touch at least three points on the touch screen 30. The at least three points are not collinear on the touch screen 30. The non-collinear three points are sufficient for determining a plane at which the touch screen 30 is located. As the industrial robot knows the coordinate of the touch pen 14 in the robot coordinate system, a first set of coordinates of the at least three points in a robot coordinate system can be recorded by the robot controller (not shown). The first set of coordinates of the at least three points in the robot coordinate system can be further communicated to the calibration controller from the robot controller. Meanwhile, the at least three points are located in the touch screen 30. The touch screen 30 also knows the coordinates of the at least three points within the touch screen coordinate system which are recorded as a second set of coordinates of the at least three points in the touch screen coordinate system. The second set of coordinates of the at least three points in a touch screen coordinate system can be further communicated to the calibration controller 40 from the touch screen 30. A relative position relationship between the camera and the industrial robot is thus determined based on the first set of coordinates and the second set of coordinates. That is, a coordinate of the touch screen 30 within the robot coordinate system can be determined based on the first set of coordinates and the second set of coordinates.

After the relative position relationship between the camera and the touch screen 30 and the relative position relationship between the industrial robot and the touch screen 30 are known, the relative position relationship between the camera and the industrial robot is determined. Accordingly, the hand-eye calibration is completed.

In some embodiments, the hand-eye calibration may be performed independently from the conveyor calibration. In some other embodiments, the hand-eye calibration may be performed in combination with the conveyor calibration. For example, the first set of coordinates and the second set of coordinates of the at least three points for hand-eye calibration may be obtained when the conveyor at the first position or at the second position. In this way, the hand-eye calibration and the conveyor calibration may share some data. Of course, the data for the hand-eye calibration may be obtained at any other position independently with the conveyor calibration.

The relative position relationship between the camera and a second industrial robot can be analogously determined. In particular, as the conveyor 20 moves to a position near a second industrial robot which is located within the work area of the second industrial robot, the manipulator 12 of the second industrial robot is instructed to touch at least three points on the touch screen 30. In this way, the relative position between the camera and the second industrial robot can be determined accordingly.

When a plurality of cameras 50 are arranged along the conveyer 20, for each camera, the relative position between the camera and each of the industrial robot can be determined likewise. In particular, the touch screen 30 is caused to display a checkerboard pattern when the touch screen is located near a second camera 50 being mounted above the conveyor 20. The second camera 50 is caused to capture an image of the touch screen 30 displaying the checkerboard pattern. A position relationship between the second camera 50 and the touch screen 30 is determined based on the captured image. After this position relationship between the second camera 50 and the touch screen 30 is determined, for each industrial robot, the touch component mounted on the respective manipulator of the industrial robot is caused to touch at least three points on the touch screen. The relative position of the second camera and the respective industrial robot is thus determined. Accordingly, the hand-eye calibration between the second camera and the industrial robot is realized.

According to the present disclosure, since the touch screen is configured to display the checkboard and provides a sufficient light illuminance for imaging, lower environment requirements for light are imposed for calibration. For example, there is no need of additional lighting sources. Also, the method can be executed with less human intervention. Thus, errors caused by human intervention are minimized.

FIG. 6 is a flowchart of a method 300 for hand-eye calibration using a touch screen according to one example embodiment of the present disclosure. At a block 302, a touch screen 30 is caused to display a checkerboard pattern. At a block 304, a camera 50 is caused to capture an image of the touch screen 30 displaying the checkerboard pattern. At a block 306, a position relationship between the camera and the touch screen 30 is determined based on the captured image.

When the hand-eye calibration is performed independent with the conveyor calibration, at a block 308, the touch pen 14 is instructed to touch at least three non-collinear points on the touch screen. At a block 310, the relative position relationship between the industrial robot and the touch screen is determined accordingly. Then, at a block 312, the relative position relationship between the camera and the industrial robot is determined. When the the hand-eye calibration is performed dependent with the conveyor calibration, the step of touching at least three non-collinear points on the touch screen can be omitted. Rather, the coordinate data obtained during the conveyor calibration may be used for hand-eye calibration.

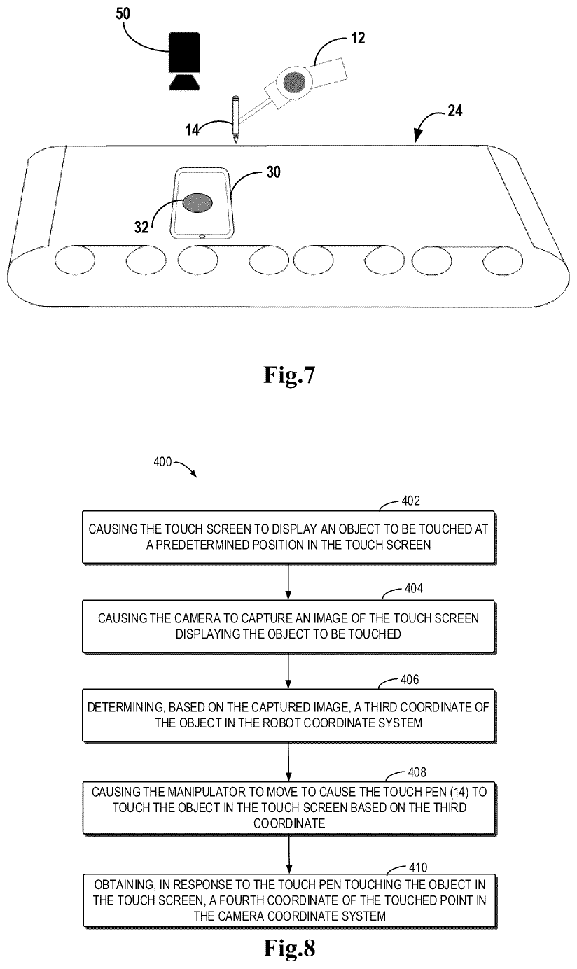

In addition, the touch screen can also be used for performances analysis of the components constituting the industrial robot system, such as the camera, the conveyor, the manipulator, and the like. FIG. 7 is an overall schematic view of a system for performances analysis of the components constituting the industrial robot system using a touch screen 30 according to one example embodiment of the present disclosure.

As shown in FIG. 7, after the peripheral devices, such as the camera 50 and the conveyor 20 are calibrated using the touch screen 30, the performances of these peripheral devices and the performances of the manipulator can be further analyzed using the touch screen 30. By displaying objects 32 on the touch screen 30, the touch pen 14 is controlled to touch the shown objects 32 on the touch screen 30. By recording the points that the touch pen 14 touches the touch screen 30, performances and/or errors of the system can be analyzed and are provided to the user.

FIG. 8 is a flowchart of a method 400 for analyzing the performances of the system using the touch screen 30 according to one example embodiment of the present disclosure. As shown in FIG. 8, at a block 402, the touch screen 30 is instructed to display an object 32 to be touched at a predetermined position in the touch screen 30. In the shown example, the object 32 is a solid circle. It is to be understood that this is merely illustrative. The size and the shape of the object 32 can be of any other proper forms. As the object 32 is shown on the touch screen 30, its coordinate is known by the touch screen 30. At a block 404, the camera 50 is instructed to capture an image of the touch screen 30 displaying the object 32. As the camera 50 has been calibrated, a coordinate of the object in the robot coordinate system can be determining based on the captured image. At a block 406, a coordinate of the object 32 in the robot coordinate system is determined based on the captured image. In some embodiments, the camera may first obtain the coordinate of the object 32 in the camera coordinate system based on the captured image and then coverts the coordinate of the object 32 in the camera coordinate system to the coordinate of the object 32 in the robot coordinate system. At a block 408, the manipulator 12 is instructed to move to cause the touch pen 14 to touch the object 32 in the touch screen 30. At a block 410, a coordinate of the touched point in the camera coordinate system is obtained in response to the touch pen 14 touching the object in the touch screen 30. By comparing the coordinate of the object 32 and the coordinate of the touched point, the imaging performances of the camera 50 and/or the picking-up accuracy of the manipulator 12 can be verified.

In some embodiments, the touch screen 30 is instructed to sequentially display a plurality of objects to be touched in a predetermined time sequence. The object 32 may be the same or be different from each other. In some embodiments, when the object 32 shown on the touch screen 30 is touched by the touch pen 14, the object 32 may disappear immediately, and a subsequent object 32 is shown on the touch screen 30. For each object to be touched, by repeating the steps performed at the blocks 402-410, a plurality of distribution points at which the touch pen 14 touches the touch screen 30 are obtained. The plurality of distribution points are then output for analyzing the imaging performances of the camera 50 and/or the picking-up accuracy of the manipulator 12 can be verified.

In some embodiments, time information that the touch pen 14 touches the object in the touch screen 30 is also obtained from the touch screen 30. The time information may indicate a time interval between two successive touching of the touch pen 14. The time information may be used for analyzing a movement performance of the manipulator 12. In some embodiments, the conveyor may also be instructed to move. The touch screen 30 is instructed to sequentially display a plurality of objects to be touched in conjunction with the movement of the conveyor. The time information may be used for analyzing a movement performance of the conveyor.

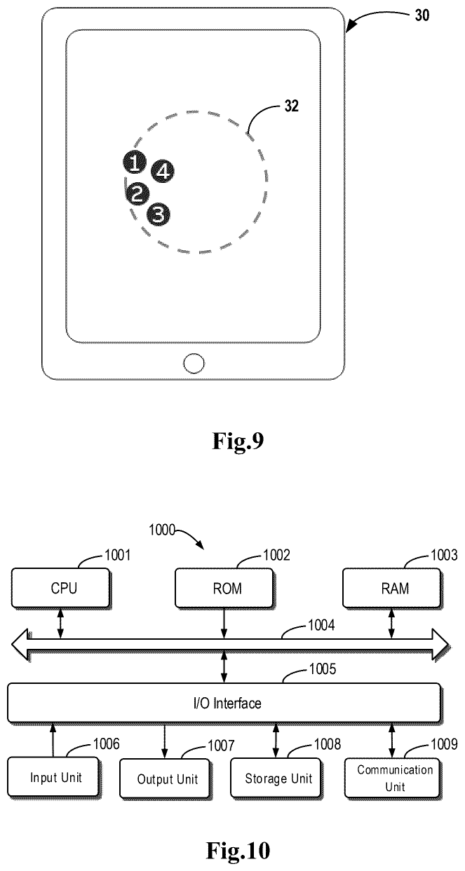

FIG. 9 shows a recording result displayed on the touch screen according to one example embodiment of the present disclosure. As shown in FIG. 9, the plurality of distribution points can be displayed on the touch screen 30. The object 32 may be shown in dashed line 32. By comparing the positions of the object 32 and the plurality of distribution points, the performances of the system, such as the overall error of the system, the picking up accuracy of the manipulator can be analyzed. In the shown example, the plurality of distribution points is located adjacent to a left side of the object 32. Thus, the picking-up points of the end effector can be adjusted so as to compensate the above error. It is to be understood that the shown example is merely illustrative. The results can be output in any other forms.

FIG. 10 illustrates a block diagram of an example device 1000 adapted to implement the embodiments of the present disclosure. As shown in the figure, a portion of the system in FIGS. 1, 2, 5, and 7 may be implemented by the device 1000. As shown in FIG. 10, the device 1000 comprises a central processing unit (CPU) 1001 that may perform various appropriate actions and processing based on computer program instructions stored in a read-only memory (ROM) 1002 or computer program instructions loaded from a memory unit 1008 to a random access memory (RAM) 803. In the RAM 1003, various programs and data needed for operations of the device 800 may also be stored. The CPU 1001, ROM 1002 and RAM 1003 are connected to each other via a bus 804. An input/output (I/O) interface 1005 is also connected to the bus 804.

Various components in the device 1000 are connected to the I/O interface 1005, including: an input unit 1006 such as a keyboard, a mouse and the like; an output unit 1007 such as various kinds of displays and a loudspeaker, etc.; a storage unit 1008 such as a magnetic disk, an optical disk, and etc.; a communication unit 1009 such as a network card, a modem, and a wireless communication transceiver, etc. The communication unit 1009 allows the device 1000 to exchange information/data with other devices through a computer network such as the Internet and/or various kinds of telecommunications networks.

Various processes and processing described above, e.g., methods 100-400, may be executed by the processing unit 1001. For example, in some embodiments, the methods 100-400 may be implemented as a computer software program that is tangibly embodied on a machine readable medium, e.g., the storage unit 1008. In some embodiments, part or all of the computer program may be loaded and/or mounted onto the device 1000 via ROM 1002 and/or communication unit 1009. When the computer program is loaded to the RAM 1003 and executed by the CPU 1001, one or more steps of the method 100-400 as described above may be executed.

Embodiments of the present disclosure relate to a method, device, system and/or computer program product. The computer program product may include a computer readable storage medium on which computer readable program instructions for executing various aspects of the present disclosure are embodied.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for calibration using a touch screen comprising:
obtaining, in response to a touch component touching at least three points being not collinear on the touch screen when a conveyor is at a first position, a first set of coordinates of the at least three points in a robot coordinate system and a second set of coordinates of the at least three points in a touch screen coordinate system, the touch component being mounted on a manipulator of an industrial robot, and the touch screen being placed on the conveyor and stationary with respect to the conveyor;
causing the conveyor to move from the first position to a second position different from the first position;
obtaining, in response to the touch component touching at least further three points being not collinear on the touch screen when the conveyor is at the second first position, a third set of coordinates of the at least further three points in the robot coordinate system and a fourth set of coordinates of the at least three further points in the touch screen coordinate system; and
determining a conveyor coordinate of the conveyor in the robot coordinate system based on the first set of coordinates, the second set of coordinates, the third set of coordinates and the fourth set of coordinates.

2. The method of claim 1, further comprising:
obtaining a first value from an encoder of the conveyor when the conveyor is at the first position;
obtaining a second value from the encoder when the conveyor is at the second position;
obtaining third values from an acceleration sensor and a gyroscope of the touch screen during movement of the conveyor from the first position to the second position;
determining, based on the third values, a moving direction and a moving distance of the touch screen during movement of the conveyor from the first position to the second position; and
determining, based on the first value, the second value, and the determined moving direction and the moving distance of the touch screen, a relationship between a count of the encoder and the movement of the conveyor.

3. The method of claim 1, wherein the touch component touching the at least three points when the conveyor is at the first position comprises causing the manipulator to move in response to a teaching input from a user to cause the touch component to touch the at least three points on the touch screen.

4. The method of claim 2, further comprising:
determining, based on the moving direction and the moving distance, a first coordinate of the touch screen in the robot coordinate system when the conveyor is at the second position; and
causing, based on the determined first coordinate of the touch screen, the manipulator to move without a teaching input from a user to cause the touch component to touch the at least further three points on the touch screen.

5. The method of claim 2, further comprising:
determining, based on at least one of the moving direction and the moving distance, whether the conveyor is a linear conveyor or a circular conveyor.

6. The method of claim 1, wherein the at least three points and/or the at least further three points are arbitrary points on the touch screen that are not collinear.

7. The method of claim 1, further comprising:
causing the touch screen to display a checkerboard pattern;
causing a camera to capture an image of the touch screen displaying the checkerboard pattern, the camera being mounted above the conveyor; and
determining, based on the captured image, a position relationship between the camera and the touch screen.

8. The method of claim 7, further comprising:
determining, based on the first and second sets of coordinates or the third and fourth sets of coordinates, a second coordinate of the touch screen in the robot coordinate system; and
determining, based on the position relationship and the determined second coordinate, a camera coordinate of the camera in the robot coordinate system.

9. The method of claim 8, further comprising:
(a) causing the touch screen to display an object to be touched at a predetermined position in the touch screen;
(b) causing the camera to capture an image of the touch screen displaying the object to be touched;
(c) determining, based on the captured image, a third coordinate of the object in the robot coordinate system;
(d) causing the manipulator to move to cause the touch component to touch the object in the touch screen based on the third coordinate; and
(e) obtaining, in response to the touch component touching the object in the touch screen, a fourth coordinate of the touched point in the camera coordinate system.

10. The method of claim 9, further comprising:
causing the touch screen to sequentially display a plurality of objects to be touched in a predetermined time sequence;
for each object to be touched, repeating the steps (a)-(e) to obtain a plurality of the touched points at which the touch component touches the touch screen; and
outputting the plurality of the touched points for analyzing a performance of at least one of the camera and the manipulator.

11. The method of claim 9, further comprising:
obtaining, from the touch screen time, information that the touch component touches the object in the touch screen; and
outputting the time information for analyzing a performance of at least one of the manipulator and the conveyor.

12. The method of claim 1, further comprising:
obtaining, in response to a second touch component touching at least three points being not collinear on the touch screen when the conveyor is at a third position different from the first position and the second position, a fifth set of coordinates of the at least three points in a second robot coordinate system and a sixth set of coordinates of the at least three points in the touch screen coordinate system, the second touch component being mounted on a second manipulator of a second industrial robot; and
determining a second conveyor coordinate of the conveyor in the second robot coordinate system based on the fifth set of coordinates and the sixth set of coordinates.

13. The method of claim 1, further comprising:
causing the touch screen to display a checkerboard pattern when the touch screen is located near a second camera being mounted above the conveyor;
causing the second camera to capture an image of the touch screen displaying the checkerboard pattern; and
determining, based on the captured image, a second position relationship between the second camera and the touch screen.

14. A system for calibration, comprising:
a touch screen placed on a conveyor associated with at least one industrial robot and stationary with respect to the conveyor; and
a controller communicatively connected to the touch screen and the at least one industrial robot, the controller being configured to:
obtain, in response to a touch component mounted on a manipulator of the at least one industrial robot touching at least three points being not collinear on the touch screen when the conveyor is at a first position, a first set of coordinates of the at least three points in a robot coordinate system and a second set of coordinates of the at least three points in a touch screen coordinate system;
cause the conveyor to move from the first position to a second position different from the first position;
obtain, in response to the touch component touching at least further three points being not collinear on the touch screen when the conveyor is at the second first position, a third set of coordinates of the at least further three points in the robot coordinate system and a fourth set of coordinates of the at least three further points in the touch screen coordinate system; and
determine a conveyor coordinate of the conveyor in the robot coordinate system based on the first set of coordinates, the second set of coordinates, the third set of coordinates and the fourth set of coordinates.

15. A computer program product comprising a computer program thereon, the computer program, when executed by a processor, caused to implement a method according to claim 1.
